(19) United States
(12) Patent Application Publication
(10) Pub. No.: US 2003/0023626 A1
(43) Pub. Date: Jan. 30, 2003

(54) Apparatus and method for creating customized business forms

(76) Inventor: Gregory J. Bretti, Fenton, MI (US)

Correspondence Address: Deniel J. Checkowsky, Plunkett & Cooney, P.C., 38505 Woodward, Suite 2000, Bloomfield Hills, MI, 48304, US

(21) Appl. No.: 10/207,336

(22) Filed: Jul. 29, 2002

Related U.S. Application Data
(60) Provisional application No. 60/308,246, filed on Jul. 27, 2001.

(51) Int. Cl. G06F 15/00

(52) U.S. Cl. 707/506

(57) ABSTRACT

A preferred embodiment of a computer system and method for creating a photo-ready business form in a digital machine electronic format includes a personal computer station for accessing and modifying or creating new business forms. In another aspect of the invention, the personal computer is remote to and connected to a central server computer, enabling multiple clients at respective remote computer stations to simultaneously retrieve and modify forms from the database of the central server. Yet another aspect of the invention provides a method of computer generating a business form, wherein a client selects a “template” from a database of selectable templates, which may include client defined templates, down-loads and fills-in the selected template and incorporates any necessary changes to the selected template to create a desired business form for use in the specific business of the client.

### CROSS-REFERENCE TO RELATED APPLICATIONS

This application is a completion application of co-pending U.S. Provisional application Serial No. 60/308,246, filed Jul. 27, 2002, the disclosure of which is hereby incorporated by reference.

### BACKGROUND OF THE INVENTION

1. Field of the Invention

The present invention relates to the field of publishing, document editing and manipulation, and displaying documents and images. More particularly, the present invention relates to an apparatus and method for enabling an author to create new and customize old business forms that are “photo ready” in one sitting.

2. Related Background Art:

The preparation of forms heretofore has largely been the responsibility of professional publishing companies using expensive high-speed printing presses. The process is tedious, labor intensive and costly, both for the large corporation as well as for the small business.

In the traditional form creation process, the form creator must go to the client to get the information and then generate a blank form based on the client's needs. Text and images are cut and pasted together to form a prototype of the form and the prototype then sent to the print shop and printed. If the client approves the form, the form would then be made “photo ready” for printing. The form must then be sent to a printer and printed, distributed, and inventoried.

If the form needs to be changed for some reason, all of these steps would be repeated should a revision be needed. This oftentimes happens when it becomes necessary to change dates, part numbers, effective dates of or the coverage of a warranty—such as required by a change in the law, or to reflect the legal status of the corporation—such as following a merger or sale of a corporate division. The previous forms may have to be scrapped and re-inventoried.

Since the introduction of the personal computer and the development of various software programs there has been an increased awareness and interest by businesses that many tasks could be done cheaper and more economically using computer based systems. One significant area of interest is in the use of the computer to eliminate the problems associated with providing forms used in business transactions.

A small business, such as an automobile dealership and like repair shops, typically cannot afford the costs of purchasing and maintaining a sophisticated computing system to do the work or to hire highly trained computer personnel to operate such a computing system. However, most businesses can afford and do have a personal computer and electronic devices (such modems and FAX machines) that interconnect the computer with the telephone lines and enable the E-mailing of messages and access to the internet.

It would be desirable to provide an author/user with a simple method of producing a customized business form, in electronic format, that is printable in-house for short runs or photo-ready for publishing at a remote print facility

### SUMMARY OF THE INVENTION

An object of this invention is the provision of a method using a computer to create a customized business form as desired.

A more particular object of this invention is the provision of a method whereby a client at a personal computer station may access documents and images, such as business forms to be modified or created, and produce new customized forms that are photo-ready in one sitting. Desirably, the client's personal computer would be remote to and connected to a central server computer that would enable multiple clients at respective remote computer stations to simultaneously retrieve and modify forms from the database of the central server.

A yet more particular object of this invention is a method of computer generating a business form, or the like, wherein the client would select a “template” from a database of selectable templates, as well as from client defined templates, down-load the template selected, and fill-in the template, as well as change the template, to provide a desired form for use in the specific business of the client.

In view of the above objects of this invention, according to one aspect of this invention, there is provided a system for creating customized forms comprising:

at least one centralized computer storing a database of compressed text and image files in the form of accessible and selectable templates,

a plurality of remote terminals each in operative communication with one or more of the centralized computers, and

means located at the site of each remote terminal for creating a business form by the system, the business form relying at least in part on an image file stored at the centralized computer.

Preferably, there is provided means located at a remote terminal for capturing graphical images and text information of client defined forms in digital form whereby to create a secondary image file and database of selectable business forms and image files over a switched telephone network between the centralized computer and a requesting remote terminal.

Further, according to another aspect of this invention, there is provided in a computer system having a display screen, a memory including a user operated program that includes a database of selectable predefined templates having different text and graphics, and a selector device such as a mouse and a keyboard for operating the computer, and a method for producing a customized business form that is photo-ready, the method comprising the steps of:

capturing textual and graphics information from a client defined form to create a text template and a graphics template corresponding to the client defined form,

storing the captured text and graphics templates in a fixed but accessible memory,

repeating the preceding steps of capturing and storing as many different text and graphics items as desired whereby to provide an accessible database of many different but selectable text and graphics templates,

laying out a desired form, the step of laying out including the steps of

selecting with the selector device and displaying on said display screen at least one template having a desired image from at least one of said database of predefined templates and client defined graphics templates,

retrieving and displaying on the display screen desired information from said text template to client customize the form, and

editing the form into a desired condition that is photo-ready.

According to an important aspect of this invention, the customized business form so laid out is then ready for a “short run” printing via a printer connected to the author's personal computer, or is “photo-ready” for sending out to a printing facility at a location remote to the personal computer. In this regard, the laid out form can be sent to the printing facility for printing via a phone line or downloaded onto a disk or CD-ROM and transported to the printing facility.

Further, the step of capturing includes interconnecting multiple personal computers to a remote central server computer whereby to enable multiple clients at their respective personal computers to simultaneously communicate their forms to a database in the central server computer or draw forms therefrom.

In regard to this latter aspect of the invention, and cognizant of the need for privacy and or security between clients, the step of capturing further includes assigning to each form captured a security identification number that would permit clients to select forms of their own as well as specific forms of other clients. Importantly, this also makes sure that two competing clients in similar market areas will not create forms with almost identical logos and other distinctive graphics.

Preferably, the step of storing onto a fixed memory location includes storing the information on a user operated computer program residing in the memory of the author's personal computer central processing unit (CPU), a read-only memory (ROM), a CD-ROM, an erasable ROM, a floppy disk, and other like memories.

After the customized form has been laid out and printed, the method includes the further step of saving the customized form to memory as a selectable template.

The method herein enables a document, such as a business form, once created, to be stored in the memory of the author's personal computer as a selectable template, and the software allows the author/user to easily use and revise the document so saved.

Advantageously, clients with technically minimal experience are provided with the ability to dynamically create, edit, and modify templated documents that are unique to their business.

Further, whether stored in the computer memory or on a portable memory device such as a CD or diskette (i.e., a “floppy”), the templates can be made available to a client. In this regard, a diskette or CD-ROM having a specially selected group of business form templates can be sold to targeted groups of users. Desirably, the templates are not loaded into and do not consume the computer RAM memory but are loaded into the personal computer on a disk only when the forms disk is desired.

In a particularly desirable aspect, geographically separated divisions of a client can be provided with access to the templated documents via a connection to the internet or like information providing source.

### BRIEF DESCRIPTION OF THE DRAWINGS

For a more complete understanding of the invention, reference is made to the following detailed description and accompanying drawings. In the drawings, like reference characters refer to like parts throughout the several views, in which:

FIG. 1 is view of a computer system for creating a customized business form,

FIG. 2 is a view of a first drop down menu which queries the user to select a template database to be used during the creating of a customized business form; and

FIGS. 3-5 are views of a second drop down menu which queries the user to select a form template from the database selected.

### DETAILED DESCRIPTION OF THE INVENTION

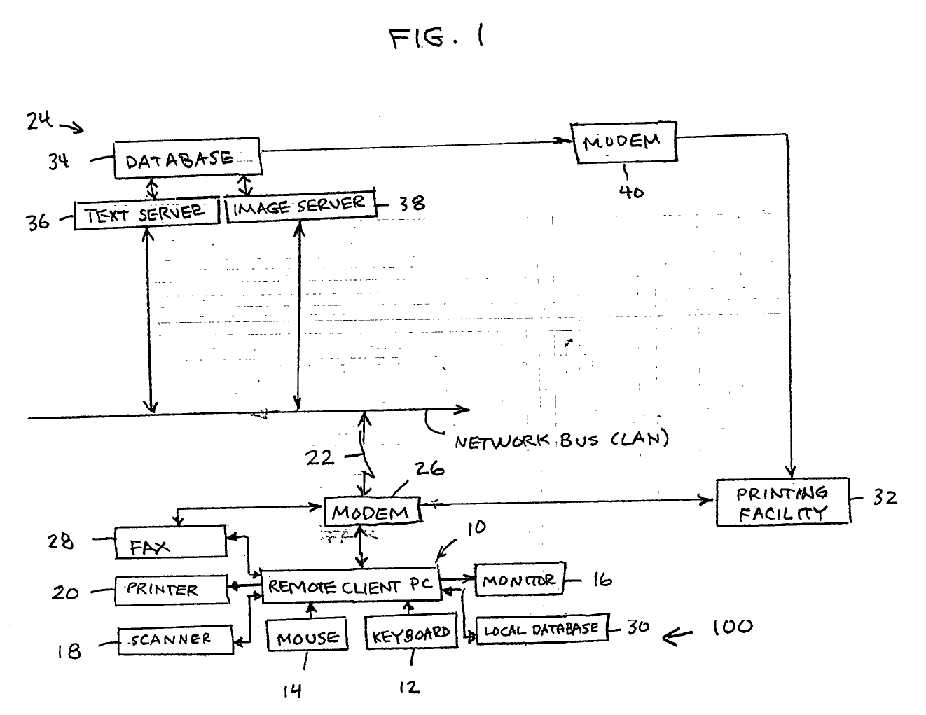

With reference to FIG. 1, an exemplary system for implementing the invention is generally indicated at 100 and includes a conventional personal computer 10. Although not shown, the personal computer 10 includes a processing unit, a system memory for storing and manipulating data, and a system bus that couples the system memory to the processing unit. The memory system includes read-only memory (ROM) and random-access memory (RAM). A basic input-output system containing the basic routines that help to transfer information between elements within the personal computer, such as during start-up, is stored in ROM. The personal computer 10 also includes a hard disk drive, a magnetic disk drive (e.g., to read from or write to a removable disk), and an optical disk drive (e.g., to read a CDROM disk).

The author of a document may enter commands and information into the personal computer 10 through a selection device, such as a keyboard 12, and/or pointing device, such as a mouse 14. A monitor or other type of display device 16 is connected to the system bus.

Associated with and operably connected to computer 10 are a scanner 18 for capturing and converting text and graphics information from a document of interest, such as a business form, into digital machine electronic format and inputting the formatted data into the computer memory, and a printer 20 for printing the form appearing on the display device 16.

The personal computer 10 may operate in a networked environment using a connection 22 to one or more remote computers 24 and accessed by a conventional communication link such as a modem connection 26 to the telephone network. Typically, the computer 10 would be connected to send and receive images and text via a FAX 28.

Preferably, the personal computer 10 would include a local database 30 into which is stored, and from which is retrieved, client defined forms. Further, the user connects computer 10, via the network connection 22, to a remote printing facility 32 to print the form when customized and made “photo ready”.

The remote computer 24 may be a central server or other common network node. As shown, the remote computer or central server 24 is connected via the connection line 22 to the personal computer 10 and includes a database memory 34 wherein image and text data is stored, a text server 36, and an image server 38.

A pre-recorded program, on a disk or other stored memory, controls the personal computer 10 for the custom design of the parameters of a business form whereby to produce a custom business form in machine format at the computer 10. These programs generally utilize “templates” and “wizards” to assist in the preparation of a document. A “template” specifies styles of headings and text in the document, tabs and margins, customized arrangements of tools and menus, and any standard content. A “wizard” is a tool that telescopes a complex process into a series of friendly windows that present only the essential choices.

Several publishing software programs exist and are commercially available for generating various documents, including business forms, such as Publisher 98® and 2000® from the Microsoft Corporation, PageMaker® from Adobe Systems, PerFORM® by Delrina Technology, and F3 Pro Designer® from the Bloc Development Corporation, to name a few. For the purposes of this discussion, the invention will be discussed in connection with the Publisher software, and more particularly, with respect to the Publisher 2000® software.

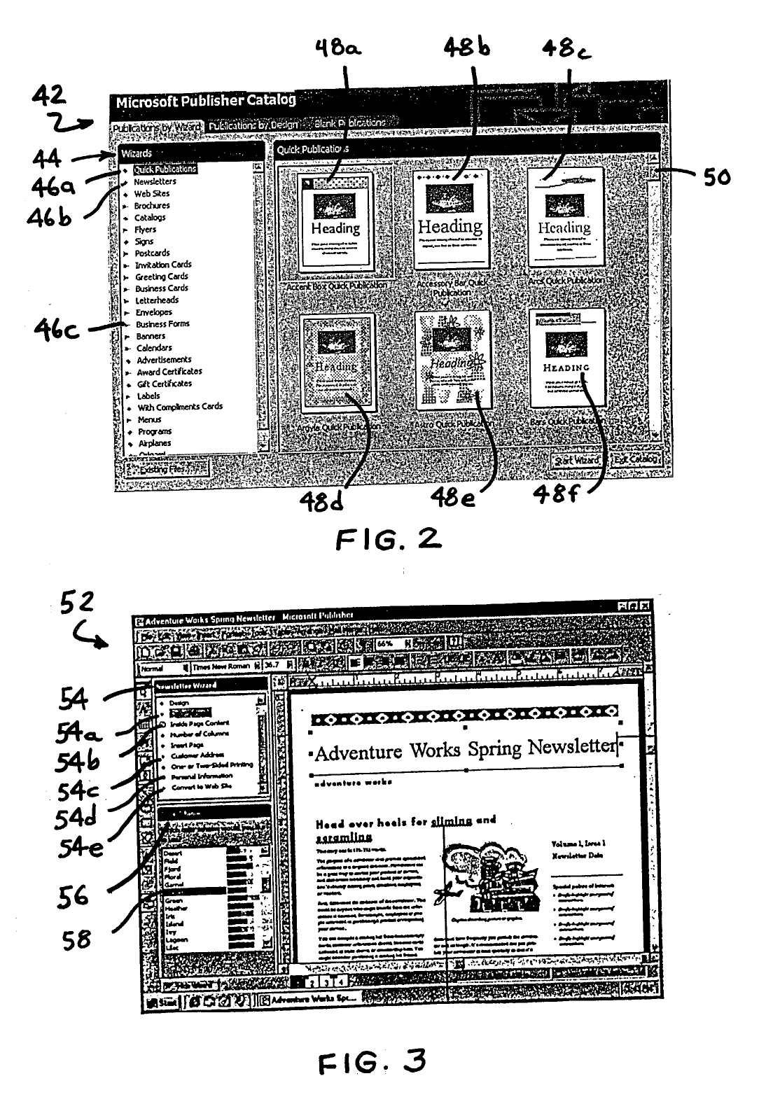

The Publisher 2000® program includes a menu-driven layout selection utility 42, forms Wizard 44, a PageManager, and an Editor, as shown in FIG. 2. The author of a document begins by selecting choices presented on a succession of menu-driven drop-down lists. Initially, the user selects the selection utility 42. This screen presents the user with a choice of using the Wizard 44 to generate a document from any of a number of generic selections 46, Publications by Design, or “Blank Publications” to generate a client defined document. The Wizard 44 includes a variety of specific “templates” which the user may select from, such as Quick Publications 46a, Newsletters 46b, and Business Forms 46c. The highlighted selection 46a provides the user with an image of the available “Quick Publication” formats 48, illustrated in FIG. 2 by the numbers 48a, 48b, 48c, 48d, 48e, and 48f in the menu window to the right of the Wizard. Additional format images may be viewed in the menu window by advancing the selection button 50 downwardly.

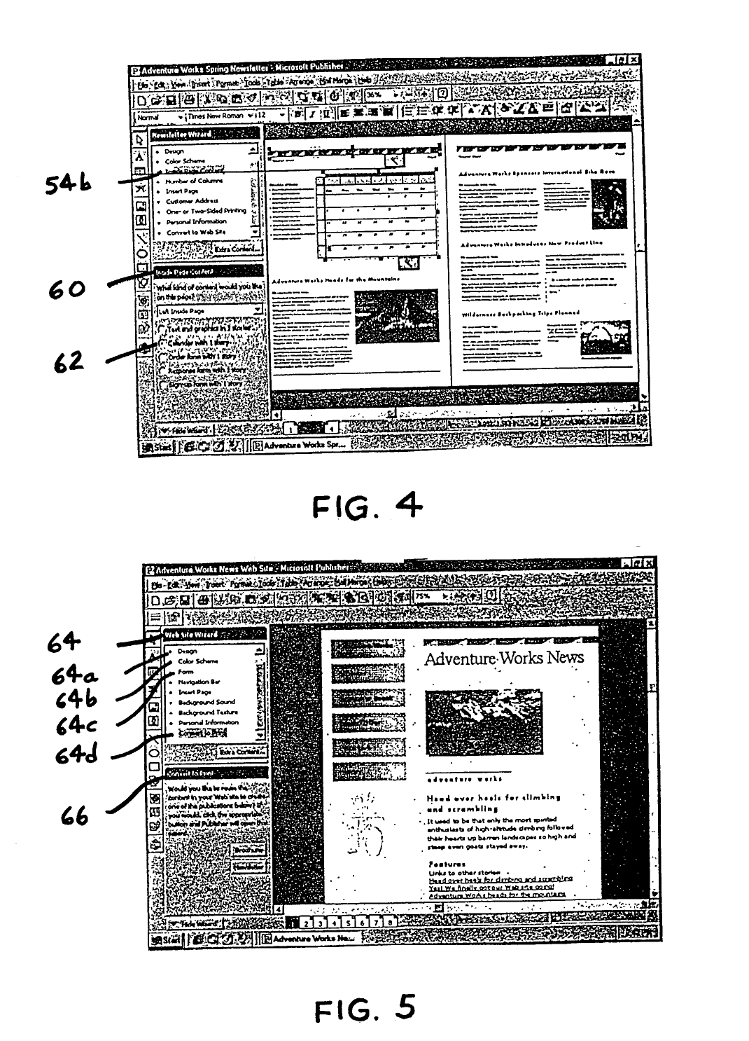

Using the mouse 14, the cursor is positioned on a specific Quick Publication format 48 in the menu window and double-clicked. This activates the form template and the Wizard brings up the form template in the next drop down menu as shown in FIGS. 3-5.

As shown in FIG. 3, the user has selected the Newsletters 46b template and the Newsletter Wizard 54 provides the user with the ability to set up the publication, such as choosing design and format options in the window, such as a Color Scheme 54a, Inside Page Content 54b, Customer Address 54c, Personal Information 54d, or Convert to Web Site 54e. Selecting one of these design and format Wizards 54a, 54b, 54c, and 54d provides a further drop down screen to fine-tune that format selection. The Color Scheme 54a Wizard provides the user with a Colors Window 56 from which various colors 58 may be selected.

By way of further illustration, as shown in FIG. 4, the user has selected the Inside Page Content 54b from the Newsletters Wizard 54. This Inside Page Wizard 60 appears as a result of this selection and the user is provided with various choices, such as a Calendar 62.

As shown in FIG. 5, the user desired to place the document on the internet and selected Convert to Web Site 54e from the Newsletter Wizard 54 (see FIG. 3). The Web Site Wizard 64 provides several choices, such as Design 64a, Color Scheme 64b, Form 64c, or Convert to Print 64d. As shown, Convert To Print 64d brings-up a Convert to Print 66 Wizard that provides further customization options.

Further, by way of example, if the user selected Business Forms 46c from the Wizard 44, the selection utility might present the following list of selection items (e.g., images) in the Business Forms window activated by the selection: invoice, customer refund, purchase order, statement, or price list. The author may then complete the last of the selection items to further define the layout as follows: number of columns, size, style choices, and masthead. The customized business form prepared with the aid of the Wizard is then saved to memory as a user defined selectable template.

The PageManager then adds previously saved author defined changes to the generic document rendered by the wizard to produce a content filled document that is passed to the Editor. The author may then make additional changes to the content filled document rendered by the PageManager to complete the current publication. Thereafter, the edited layout is saved to memory as a selectable template.

In the practice of the invention, an exemplary method is as follows: First, a database of selectable client defined forms is created. The database may be created by the network administrator at the central computer 24 or by a client at the personal computer 10.

Then the user scans graphics and/or text material from a suitable source, such as a preexisting and pre-defined client form, thereby capturing into digital machine format the text and graphics information from the client form. This creates a selectable text template and a graphics template corresponding to the client defined form.

These captured text and graphics images are then stored in a fixed memory, but accessible memory, such as that of personal computer 10, the local database 30, or on a CD-ROM or “floppy” diskette that is inserted into the computer. The templates may also be stored into the central memory 34 of the remote central server computer 24. This scanning or capturing step is repeated for each form that the client wishes to have available whereby to provide an accessible database of as many different but selectable text and graphics templates as desired.

The client then opens the Publisher 2000 program, whereupon the menu driven program queries the user as to what steps are to be taken. There are two possibilities: the client either recalls and prints a client-defined form, or requests and modifies a template from the selectable databases of the client defined forms or the Publisher2000 program. In the first instance, once recalled, the client prints the preexisting form.

If the form needs to be laid out or a preexisting form otherwise modified, the client uses the selector device to select and display on the display screen at least one template having the desired image from at least one of the database of predefined templates in Publisher2000 and/or the client defined graphics templates.

In some cases, a preexisting form will be modified. The desired information is entered or retrieved from the text template to client customize the form.

If the client wishes to generate a new form, the user selects the Wizard and selects a possible form from the program. The Wizard program module renders a generic document in a first layout.

The author makes changes to the generic document while the document is in the first layout, typically by adding content and making author-defined changes to the document rendered by the Wizard. The author may then return to the menu-driven utility to select a second layout for the document. The Wizard renders a generic document in the second layout and the publisher program system automatically applies the author's changes to the document and renders a content-filled document in the second layout.

Additionally, the client may access the client-defined templates for text matter and import the text from a client defined form into the computer-generated form.

The form on the display is edited, as desired, until it is “photo-ready”. Thereafter, the form can be stored to memory, printed on the printer 20 connected to the personal computer 10 of the client, or sent to a printing facility 32 remote to the computer for “formal” printing via the modem 26, such as where the number of copies to be printed is large, the graphics need to be highly enhanced, or there are multiple color zones.

Additionally, the form can be created at the remote central server computer 24, and transmitted by a modem 40 connected thereto to the remote printing facility 32. The central computer would include the necessary equipment to create the requisite form, such as the mouse, keyboard and the like equipment (not shown) described hereinabove for the personal computer.

After the customized form has been laid out and printed, the method includes the further step of saving the customized form to memory as a selectable template.

According to an important aspect of this invention, the customized business form so laid out is then ready for a “short run” printing via a printer connected to the author's personal computer, or is “photo-ready” for sending out to a printing facility at a location remote to the personal computer. In this regard, the laid out form can be sent to the printing facility for printing via a phone line or downloaded onto a disk or CD-ROM and transported to the print facility.

Further, the step of capturing includes interconnecting multiple personal computers to a remote central server computer 24 whereby to enable multiple clients at their respective personal computers 10 to simultaneously communicate their forms to a database in the central server computer or draw forms therefrom.

In regard to this latter aspect of the invention, and cognizant of the need for privacy and or security between clients, the step of capturing further includes assigning to each form captured a security identification number that would permit clients to select forms of their own as well as specific forms of other clients. Importantly, this also makes sure that two competing clients in similar market areas will not create forms with almost identical logos and other distinctive graphics.

Preferably, the step of storing onto a fixed memory location includes storing the information on a user operated computer program residing in the memory of the authors personal computer central processing unit (CPU), a read-only memory (ROM), a CD-ROM, an erasable ROM, a floppy disk, and other like memories. The client form can be protectively stored to permit the client only to have access to the client's own forms, or permit multiple users to have access to a form to create a “pooled form” stored onto the computer.

The apparatus and method herein described enables a document, such as a business form, once created, to be stored in the memory of the author's personal computer as a selectable template, and the software allows the author/user to easily use and revise the document so saved. The description of the invention, however, is merely exemplary in nature, and thus, variations that do not depart from the gist of the invention are intended to be within the scope of the invention. Such variations are not to be regarded as a departure from the spirit and scope of the invention.

What is claimed is:

1. A computer system for creating customized business forms, the system comprising:
at least one remote computer having an accessible memory location for storing retrievable text and image data in the form of selectable templates;
at least one personal computer that is in operative communication with at least one of the at least one remote computers; and
wherein the at least one personal computer includes means for creating a computer generated business form using at least one of the selectable templates stored in the memory location of the at least one remote computer.

2. The system of claim 1, further comprising a local database operably connected to at least one of the at least one personal computer for storing the computer generated business form.

3. The system of claim 2, further comprising a scanner operably connected to at least one of the at least one personal computer for capturing text and graphics data from a tangible document and converting the data into a digital machine electronic format.

4. The system of claim 3, wherein the captured text and graphics data is stored in the local database.

5. The system of claim 3, wherein the captured text and graphics data is stored in the accessible memory location of at least one of the at least one remote computer.

6. The system of claim 2, wherein the business form stored on the local database is retrievable using at least one of the at least one personal computer.

7. The system of claim 1, further comprising at least one printing facility in operative communication with at least one of the at least one personal computer.

8. The system of claim 7, wherein at least one modem operably connects at least one of the at least one of the at least one personal computer to the at least one printing facility.

9. The system of claim 1, further comprising at least one printing facility in operative communication with at least one of the at least one remote computers

10. The system of claim 9, wherein at least one modem operably connects at least one of the at least one of the at least one remote computer to at least one of the at least one printing facility.

11. The system of claim 1, wherein at least one of the at least one remote computer is a central server computer.

12. The system of claim 11, wherein at least one of the at least one central server computer is comprised of a text server and an image server.

13. The system of claim 1, wherein at least one of the at least one remote computer includes means for creating a computer generated business form.

14. The system of claim 1, wherein at least one modem operably connects at least one of the at least one personal computer to at least one of the at least one remote computer.

15. A method for creating a custom photo-ready business form in a digital machine electronic format, the method comprising the steps of:
(a) providing a database of templates, a personal computer, a selection device, a display device, and a fixed memory location;
(b) selecting a template from the database of templates using the selection device operably connected to the personal computer;
(c) displaying the selected template on the display device operably connected to the personal computer;
(d) editing the selected template to create a client-defined business form; and
(e) storing the client-defined business form in a digital machine electronic format onto the fixed memory location.

16. The method of claim 15, further comprising:
repeating steps (b) through (d) to produce a database of multiple client-defined business forms.

17. The method of claim 15, wherein the personal computer is a remote central server.

18. The method of claim 15, wherein the fixed memory location is an erasable ROM, a ROM, or a floppy disk.

19. The method of claim 15, wherein the template selected from the template database is a previously generated client-defined business form.

20. The method of claim 15, wherein the template selected from the template database is a predefined template that is included as part of a publishing software program used to create the client-defined business form.

21. The method of claim 15, further comprising the step of printing the client-defined business form on a printer operably connected to the personal computer.

22. The method of claim 15, further comprising the step of sending the client-defined business form to a printing facility for printing.

23. A method for creating a database of business form templates in a digital machine electronic format, the method comprising the steps of:
(a) capturing text and graphic information from a tangible document and converting the captured information into a digital machine electronic format;
(b) creating a text and graphics template that corresponds to the captured information;
(c) storing the text and graphics template in a fixed memory location as a client-defined business form; and
(d) repeating steps (a) through (c) for multiple tangible documents to create a database of selectable text and graphics templates.

24. The method of claim 30, wherein a scanner is used to capture the text and graphic information.

25. The method of claim 30, further comprising the step of assigning a security identification number to the client-defined business form.
